(19) United States
(12) Patent Application Publication
(10) Pub. No.: US 2016/0225069 A1
(43) Pub. Date: Aug. 4, 2016

(54) NEEDS BASED AUCTION BIDS, INQUIRY BIDS, AND BID TO DEAL CONVERSION

(71) Applicant: Charles Wagner, Austin, TX (US)

(72) Inventor: Charles Wagner, Austin, TX (US)

(73) Assignee: HomeAway, Inc., Austin, TX (US)

(21) Appl. No.: 14/613,352

(22) Filed: Feb. 3, 2015

(51) Int. Cl. G06Q 30/08

(52) U.S. Cl. CPC G06Q 30/08

(57) ABSTRACT

A system configured to receive data representing a bid from a customer (e.g., a consumer, a user, a traveler) may be operative to place the bid on one or more products that satisfy the same need (e.g., property listings) for one or more bid prices and may be operative to submit the bid(s) to sellers (e.g., owners) of the one or more listings. An auction for the product may be terminated by elapsing of a bid window, by one of the owners being the first to accept the customers bid, or by the customer accepting an owner's counter offer. The system may present data representing inquiry bids that may meet the needs of the customer. The system may communicate data with another system that may publish data representing a deal or deals generated by an owner(s).

### FIELD

The present application relates generally to systems, software and electronic commerce. More specifically, techniques associated with bidding on properties for purchase, rent or lease from owners of properties are disclosed.

### BACKGROUND

In some systems, customers who wish to purchase, rent or lease a property in a given locale, for a given period of time, and at a given price may turn to an inquiry service (e.g., a listing site driven by a search engine) where listings of available properties that meet the customer's requirements for location, prices, availability dates, etc., may be browsed and/or searched. Typically, the customer is presented with several property listings to choose from. If the customer finds a suitable listing and makes an offer on that listing, then an inquiry (e.g., via an inquiry service) may be made on behalf of the customer to the owner of the listing. In some instances, the customer may have to wait for an unspecified period of time for the owner to reply with an acceptance or rejection of the offer. The hazards associated with the customer making multiple offers to multiple owners include more than one owner accepting and the possibility of the customer being legally bound to perform on a contract with each accepting owner. Both the owner and customer may have to deal with payment systems that are burdensome or require older forms of payment such as a check, for example. Typically the owner wants assurances that he/she will be paid and the customer wants assurances that after payment is made, the listing will be available for occupancy for the dates specified. However, things may not go according to plan and the owner may not get paid (e.g., the customer cancels) or the listing may become unavailable to the customer (e.g., the owner cancels, or the owner or the traveler never respond after an inquiry booking is initiated).

Thus, there is a need for devices, systems, and methods that allow a customer and an owner to easily and securely consummate a transaction with confidence that the owner will be paid and the customer will gain occupancy.

### BRIEF DESCRIPTION OF THE DRAWINGS

Various non-limiting embodiments or examples (“examples”) of the present application are disclosed in the following detailed description and the accompanying drawings. The drawings are not necessarily to scale:

FIG. 1 depicts an example of a flow diagram for needs based auctioning;

FIG. 2 depicts another example of a flow diagram for needs based auctioning;

FIG. 3 depicts yet another example of a flow diagram for needs based auctioning in which an owner presents a counter offer to a customer;

FIG. 4 depicts a block diagram of one example of a needs based auction system;

FIG. 5 depicts a block diagram of another example of a needs based auction system;

FIG. 6 depicts a block diagram of one example of counter offer handling in a needs based auction system;

FIG. 7 depicts examples of inquiry bids in a needs based auction system;

FIG. 8 depicts an example block diagram and an example flow chart for converting bids to deals; and

FIG. 9 illustrates an exemplary computer system that may be used in a needs based auction system.

### DETAILED DESCRIPTION

Various embodiments or examples may be implemented in numerous ways, including as a system, a process, a method, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

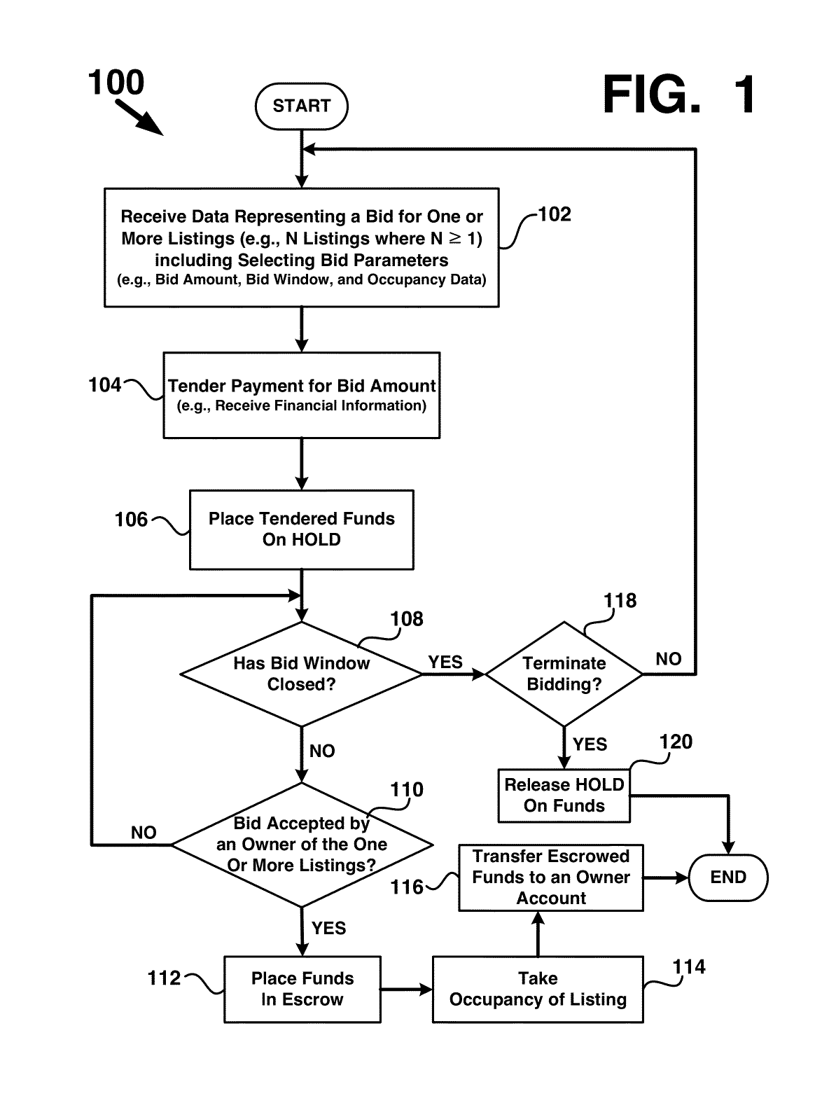

FIG. 1 depicts an example of a flow diagram 100 for needs based auctioning. In some examples, flow 100 may be implemented as a system. In other examples, flow 100 may be implemented as a process. At a stage 102 data representing a bid may be received (e.g., a customer may submit a bid at a given amount (e.g., in dollars) for one or more listings) such as N listings (e.g., one or more properties for purchase, rent, or lease), where N may comprises an integer that is greater than or equal to one (e.g., N≧1). At the stage 102, the data representing the bid may optionally include bid parameters including but not limited to: (a) a bid window (e.g., a temporal window in seconds, minutes, hours, days, weeks, etc. before the bid expires, that is, the customers offer(s) can no longer be accepted by an owner(s) of the listing(s)); (b) occupancy data (e.g., times and dates for occupancy of the listings being bid on); and (c) a bid amount (e.g., in dollars or other form of currency, payment, electronic transaction, etc.). An owner may comprise a direct owner of the listing, may comprise a property manager or some other agent authorized to act on behalf of the direct owner(s), or a joint owner of the listing, for example. In some examples, a customer may be queried as to whether or not they would like to place a bid on one or more listings they have selected or has browsed using a dashboard, GUI, or some other interface. In other examples, bid amounts may be suggested to the customer for listings the customer has selected or has browsed using a dashboard, GUI, or some other interface. After a customer enters a bid, a likelihood (e.g., a percentage) that an owner of a listing will accept the amount bided may be presented to the customer using a dashboard, GUI, or some other interface. The bid amount entered by the customer may be the suggested amount or a different amount. A customer may also be referred to as a bidder, a consumer, or a traveler, for example. An owner may also be referred to as a seller, a landlord, property manager, or an agent, for example. Each listing may be one of multiple products that satisfy the same need of the customer, that is, a need for a property (e.g., a vacation rental, bread-and-breakfast, apartment, hotel room, house rental, etc.) to stay in for a specified period of time, for example. In other examples, the bid amount may be created by the system (e.g., the needs based auctioning system), may be suggested by the owner via the system, or may be suggested by the customer (e.g., the traveler).

At a stage 104 payment for the bid amount may be tendered (e.g., financial information may be received, such as credit card number, etc.). Tendering payment for the bid amount may occur over a payment service (e.g., an electronic, Internet based, or web based payment system) or the like where the customer enters credit card, bank account information, or electronic payment information as a source of the funds for payment of the bid amount as will be described in greater detail below.

At a stage 106 the tendered funds may be placed on HOLD. That is, the bid amount has either been withdrawn (e.g., electronically debited) from the customer's account or an account balance of the customer's account has been reduced by the bid amount, pending actual consummation of the transaction between the customer and an accepting owner. A guarantee of payment of funds may include but is not limited to placing a hold on a credit card, deducting funds from an account or card and then refunding those funds if necessary, holding funds in escrow, holding the funds as a deposit. The funds on hold need not exceed the highest amount bid. As one example, if listing A is $500, listing B is $1000, and listing C is $1500, then a customer may have to pay the $1500 (e.g., the highest listing price) to secure the bid, and not $3000 (e.g., $500+$1000+$1500=$3000). Upon confirmation of the deal (e.g., a bid is accepted) at least a portion of the funds on hold may be refunded as described above. For example, if the bid for listing A at $500 is accepted, then $1000 of the $1500 on hold may be refunded to the customer. There may be multiple permutations and options for holding and transferring funds and above are non-limiting examples.

At a stage 108 a decision as to whether or not the bid window has closed may be made. For example, if the customer set the bid window at 48 hours, then after 48 hours have elapsed, the window for owners to accept the customer's bid (e.g., the customer's offer price and/or terms) has closed. If a YES branch is taken from the stage 108, then flow 100 may continue at another stage, such as a stage 118, for example. On the other hand, if a NO branch is taken from the stage 108, then the flow 100 may continue at another stage, such as a stage 110, for example. In some examples, the customer need not set the bid window (e.g., as one bid parameter at the stage 102) and the bid window is set to a default value, such as 24 hours, for example.

At the stage 118, a determination may be made to terminate the bidding. If a NO branch is taken from the stage 118, then flow 100 may continue at another stage, such as the stage 102 where the customer may again attempt to submit another bid price for one or more listings and may select the parameters for the bid as described above. The one or more listings may be different for each pass through the stage 102, for example. Accordingly, one or more of the bid amount, the number of listings, or the bid parameters may change with each pass through the stage 102. If the YES branch is taken from the stage 118, then the flow 100 may continue to a stage 120 as will be described in greater detail below.

Returning to the stage 108, If the NO branch is taken from the stage 108 (e.g., bidding has not closed), then flow 100 may continue at the stage 110 where a determination may be made as to whether or not an owner of one of the N listings has accepted the customer's offer for the bid amount. An owner's acceptance of a customer's offer may include the owner's acceptance of the bid parameters as well. Acceptance may be by any acceptable communications medium, preferably a medium that is reliable and may include a time and date stamp as assurance that an acceptance is timely (e.g., acceptance occurred before closing of bid window and is the first acceptance). Examples of acceptable mediums include but are not limited to email, text message, voice mail, VoIP, telephone, SMS, web site, web page, and instant messaging (IM), just to name a few.

If a YES branch is taken from the stage 110, then the flow 100 may continue at another stage, such as a stage 112 where the funds (e.g., the bid amount) may be received into escrow (e.g., an escrow account, a neutral third party account, or the like). The escrowed funds may be managed by a disinterested third party for benefit of the customer, the owner, or both. Receiving (e.g., placing the funds) the funds in escrow account may have advantages including but not limited to ensuring the funds are available for disbursement to the owner when the customer takes occupancy of the listing (e.g., a leasehold, real property, apartment, condo, townhouse, cabin, studio, flat, hut, home, hotel/motel room, hostel room, dorm room, bed room in a house, etc.), ensuring the funds are available for disbursement to the customer when there is a cancellation by the owner or none of the owners of the N listings accepts the customers bid, may allow for a refund to the customer for whatever circumstances that arise for which a refund is due to the customer, just to name a few. Conversely, if a NO branch is taken from the stage 110, then flow 100 may continue at another stage, such as the stage 108 where the determination of bid window closing may again be tested as described above.

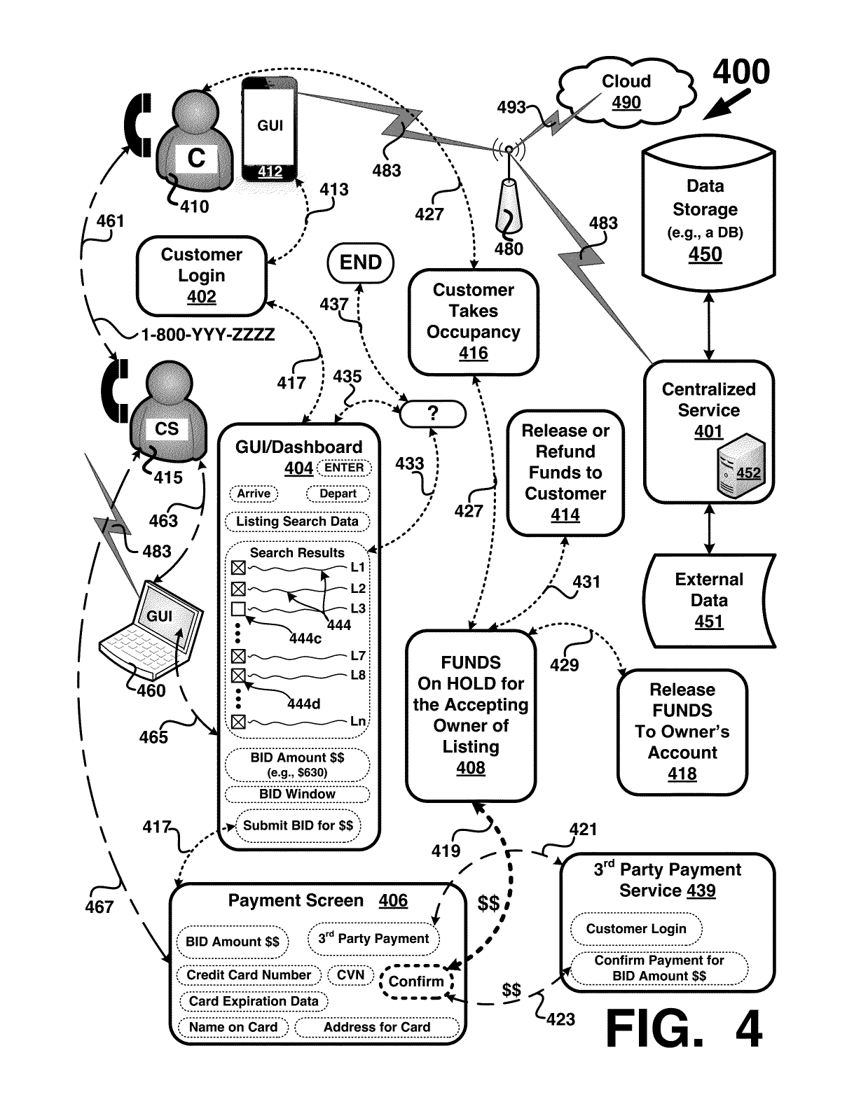

After funds are escrowed at the stage 112, flow 100 may continue at a stage 114. At the stage 114 occupancy of the listing may be taken (e.g., by the customer) and/or data representing a notification that occupancy may be taken at an agreed upon time/date (e.g., via bid parameters) may be communicated (e.g., electronically to a computing device, by email, by text message, IM, SMS, a Tweet, etc.). Taking occupancy may include the owner or an agent representing the owner providing necessary access materials (e.g., door keys, lock codes, access codes, access credentials, etc.) to the customer to enable access to the listing. Occupancy may comprise the customer or other person(s) associated with the customer gaining physical access to the listing (e.g., a condo, apartment, residence, etc.). At the stage 114, the customer may be notified that he/she may take occupancy of the listing, and may take some future action to garner occupancy of the listing (e.g., obtain the keys and enter the listing). A system (e.g., in examples 400-600 of FIGS. 4-6) may notify the customer (e.g., via email SMS, text message, voice mail, etc.) that occupancy of the listing may be taken by the customer as a result of funds being placed in escrow for benefit of the owner of the listing.

After occupancy has been taken, flow 100 may continue at a stage 116. At the stage 116, the previously escrowed funds (e.g., at the stage 112) may be transferred to an owner account (e.g., deposited in the owners bank account or other form of financial account). The transfer of funds at the stage 116 may occur at some designated time, such as on the first day of occupancy or on the last day of occupancy, for example. Actual timing of the transfer at the stage 116 may be application dependent and the above are non-limiting examples of how transfer of the escrowed funds at the stage 116 may be implemented. Flow 100 may terminate (e.g., END) after completion of the stage 116, for example.

Referring back to the YES branch that was taken from the stage 118 to the stage 120, at the stage 120 the HOLD placed on the tendered funds at the stage 106 may be released. The released funds may be transferred or otherwise re-deposited back into an account (e.g., the customer's account) from which they were taken or to some other designated account, for example. In some examples, the HOLD on the funds may not involve an actual transfer of those funds to another account, but may comprise setting aside the amount of the held funds from a balance of funds available in the customer's account in the event an owner accepts the customer's bid at some future time (e.g., the YES branch of the stage 110). Flow 100 may terminate (e.g., END) after completion of the stage 120, for example.

For example, a customer may, prior to flow 100: search for listings; review suitable listings resulting from the search; select listings to bid on (e.g., via a user interface (UI), gesture recognition, voice recognition, using a mouse, a keyboard, a stylus, verbal instructions, etc.); and then place a bid for a specific amount (e.g., a $620 bid amount) for selected listings. Owners of the selected listings may review the bid offer, the bid parameters, and decide whether or not to accept the bid amount. As will be described below, an owner of a listing may reply to the customer with a counter offer amount (e.g., a $655 counter offer price vs. the $620 bid amount) for the customer to accept or reject. An owner may find the bid amount acceptable but may not find some or all of the bid parameters acceptable. Accordingly, a counter offer may comprise alternative bid parameters provided by the owner. The bid window closing (e.g., at the stage 108) may be operative as a rejection of an owner's counter offer by the customer. The customer may accept an owner's counter offer as to bid amount, bid parameters, or both.

In flow 100 there may be a single bid amount that applies to all N listing selected by the customer. However, in some examples a customer may prefer to enter different bid amounts for some or all of the N listings selected as will be described below in greater detail. In the flow 100, after the stage 112, circumstances may arise that require a refund of funds to the customer (e.g., the owner cancels, the listing becomes unavailable for whatever reason, etc.). If a refund is to be given to the customer any time after the stage 112, then the some or all of the funds in escrow may not be transferred to the owner.

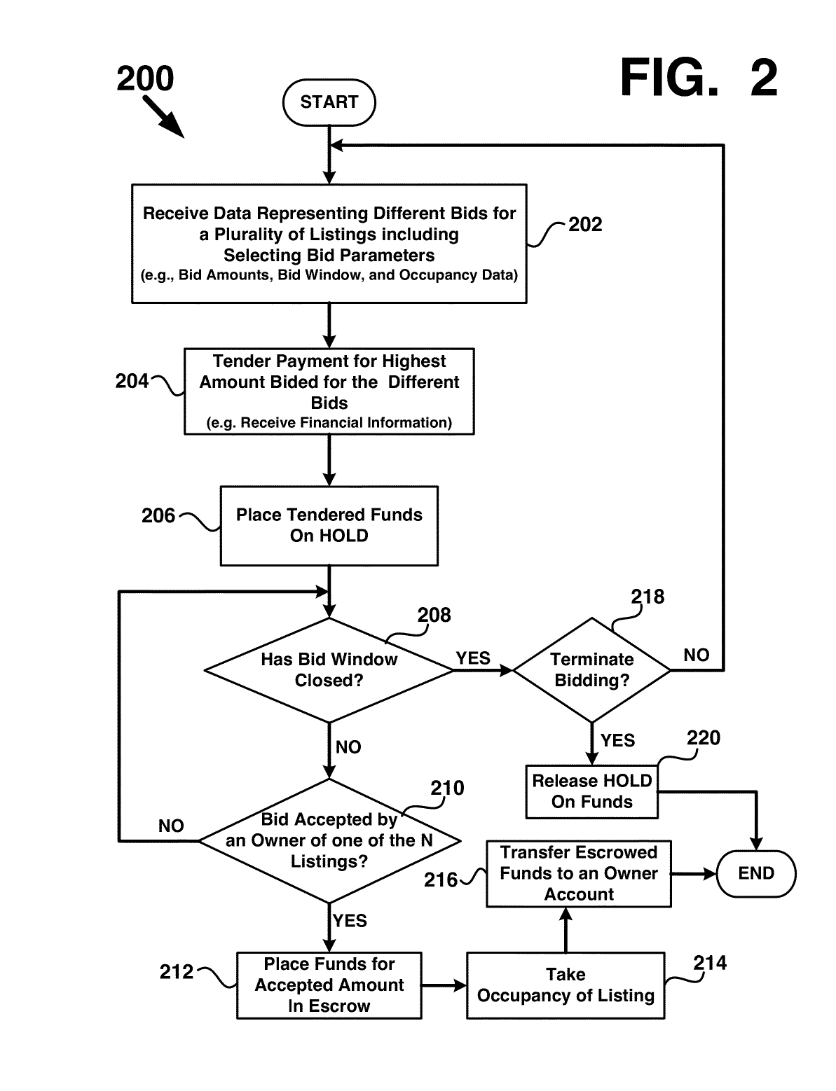

FIG. 2 depicts another example of a flow diagram 200 for needs based auctioning. In some examples, flow 200 may be implemented as a system. In other examples, flow 200 may be implemented as a process. In contrast to the flow 100 described above, at a stage 202, data representing different bids (e.g., M different bids) for multiple listings (e.g., where N≧2 and where M≧2 but is not greater than N). For example, after searching for suitable listings, the customer finds six listings that meet the customer's requirements (e.g., location, availability dates, accommodations, etc.) and the customer may places six different bids on each of the six listings with the bid amount varying for at least two of the six listings. As another example, for listings L1-L6, the customer places the following bids: L1=$125; L2=$110; L3=$145; L4=$220; L5=$115; and L6=$200. Here, all the bid amounts are different dollar amounts for each of the six listings and M=6 and N=6. In yet another example, for listings L1-L4, the customer places the following bids: L1=$225; L2=$255; L3=$255; and L4=$200. Here, two of the listings have the same bid amount of $255 and two of the listings have different bid amounts of $200 and $225. Therefore, N=4 and M=3.

At the stage 202, the data representing the different bids may optionally include bid parameters (e.g., selected by the customer) which may be the same or different for the N listings. The bid parameters may including but are not limited to: (a) a bid window (e.g., a temporal window in seconds, minutes, hours, days, weeks, etc. before the bid expires, that is, the customers offer(s) can no longer be accepted by an owner(s) of the listing(s)); (b) occupancy data (e.g., times and dates for occupancy of the listings being bid on); and (c) a bid amount (e.g., in dollars or other form of currency, payment, electronic transaction, etc.). An owner may comprise a direct owner of the listing, may comprise a property manager or some other agent authorized to act on behalf of the direct owner(s), or a joint owner of the listing, for example.

At a stage 204 a payment for the highest amount bided in the M bid amounts may be tendered so that sufficient funds are available in the event the owner having the listing with the highest amount bided accepts the customers offer, and there are more than sufficient funds available for owner's having listing with lower bid amounts. Accordingly, if M=8 and the bid amounts are: $177; $195; $200; $227; $250; $199; $210; and $248), then the highest amount of the eight bided prices is $250 and the $250 will be tendered by the customer even though the bid may be accepted by a listing having one of the lower bid amounts (e.g., $199). In this example N≧M so that the eight different bid amounts would be spread across at least eight different selected listings.

At a stage 206 the tendered funds are placed on a HOLD as described above. At a stage 208 a determination is made as to whether or not the bid window has closed. If the NO branch is taken, then at a stage 210 a determination is made as to whether or not any of the owners of the N listings has accepted the amount bided for their listing. If the owner of one of the N listings has accepted, then a YES branch is taken to a stage 212 where the funds are placed in escrow as described above and the flow 200 may continue to a stage 214 where occupancy may be taken (e.g., by the customer). At a stage 216, the escrowed funds are transferred to an owner account (e.g., deposited in the owner's bank account). If the NO branch is taken from the stage 210, then the flow 200 may return to the stage 208. As was described above, if the YES branch is taken from the stage 208, then at a stage 218 a determination may be made to terminate or not terminate the bidding. If the YES branch is taken from the stage 218, then at a stage 220 a release of the funds on HOLD is made and the flow 200 may terminate. If the NO branch is taken from the stage 208, then the flow 200 may return to a prior stage, such as the stage 202 where the customer may submit different bid parameters, different values for N and M, and may retry the bidding process in an attempt to obtain a more favorable outcome.

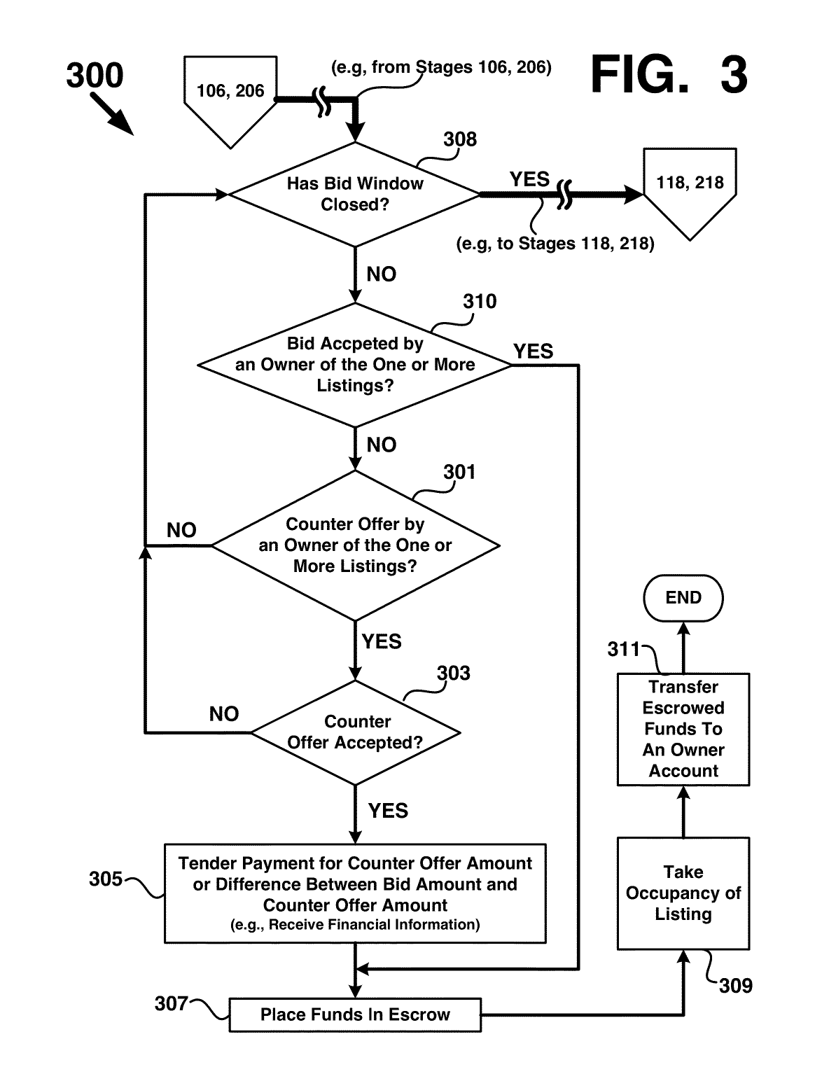

FIG. 3 depicts yet another example of a flow diagram 300 for needs based auctioning in which an owner presents a counter offer to a customer. In some examples, flow 300 may be implemented as a system. In other examples, flow 300 may be implemented as a process. Assuming for purposes of explanation that at a stage 308 of flow 300, the bid window has not closed as described above for the stages (108, 208) and that at a stage 310 of flow 300, a bid has not been accepted by an owner of the one or more listings as described above for the stages (110, 210), then NO branches may be taken from the stages 308 and 310, and flow 300 may continue at a stage 301 where a determination may be made as to whether or not one or more owners of the one or more listings being bid on has made a counter offer (e.g., as to bid amount and/or bid parameters). If a NO branch is taken from the stage 301, then the flow 300 may return to a prior stage such as the stage 308. If a YES branch is taken from the stage 301, then the flow 300 may continue to a stage 303 where a determination may be made as to whether or not there has been an accepted of the owner's counter offer. If a NO branch is taken from the stage 303, then the flow 300 may return to a prior stage such as the stage 308. If a YES branch is taken from the stage 303, then the flow 300 may continue at a stage 305 where payment may be tendered for the amount of the counter offer or payment that is the difference between the original bid amount and the counter offer amount may be tendered. For example, if the original bid amount from the customer is $520 and an owner counter offers for $570, then at the stage 305 the customer may tender payment in the amount of $570. Alternatively, the customer may tender payment in the amount of the difference (e.g., the delta Δ) between the first bid amount and the counter offer amount such that the amount of the payment to be tendered is ($570−$520=$50).

As one example, a first token may be set (e.g., by a credit card company or other financial institution that handles the transaction) for the original bid amount of $520 and the first token may be used to make an additional charge to the customer's account for the delta Δ of $50. On the other hand, as a second example, a customer's acceptance of the owner's counter offer may generate a second token that is different than the first token, and the second token may be used to charge the delta Δ of $50 to the customer's account. The amounts associated with the first token, the second token, or both may be placed on HOLD as described above and/or may be escrowed as described above. The first and second tokens may comprise a single charge and a double charge or a single charge and a supplemental charge to an account(s) of the customer.

Although bid amount is depicted at the stage 305, the counter offer may comprise the owner's modification of the bid parameters, and the counter offer may comprise a change in the bid amount, the bid parameters, or both, as described above. A customer's acceptance of an owner's counter offer may comprise the customer accepting the owner's modification of the bid parameters, the bid amount, or both. Customer acceptance of an owner's modification of the bid parameters may be memorialized in a contract or other document that may be drafted or otherwise generated upon acceptance of the counter offer. Here, the owner may not want to pursue the customer for the funds needed to consummate the transaction and the customer may not want uncertainty in obtaining occupancy of the listing if the bid amount is accepted by an owner. Accordingly, the placing of funds on HOLD and/or subsequent escrowing of the funds provides both parties with assurance that their interests are being served without having to personally interact with each other to negotiate payment of funds.

Flow 300 may transition from the stage 305 to another stage, such as a stage 307. At the stage 307 the funds may be placed into escrow as described above. Flow 300 may transition from the stage 307 to another stage, such as a stage 309. At the stage 309 occupancy of the listing may be taken as described above in reference to FIGS. 1 and 2. Flow 300 may transition from the stage 309 to another stage, such as a stage 311. At the stage 311 the funds may be transferred from escrow to the owner (e.g., deposited in the owner's bank account) as was described above.

At the stage 305, the payment tendered may be placed on HOLD (not shown) as described above, and then later placed in escrow at the stage 307. In that the counter offer, if accepted by the customer, may generate another transaction requiring tendering of payment (e.g., at the stage 305), there may be more than one HOLD placed on funds from the customer such as at the stage 106 or 206, and at the stage 305. The first HOLD may be associated with the original bid amount described in flows 100 and 200 above and the second HOLD may be associated with acceptance by the customer of a counter offer as described in the flow 300.

If a counter offer is accepted by the customer, the funds for the first HOLD may be released (120, 220) and/or refunded as described above. The second HOLD may result in the full amount of the counter offer being placed on HOLD (e.g., $570) or only the Δ between the original bid amount and the counter offer amount is placed on HOLD (e.g., $50). The flows 100-300 as depicted in FIGS. 1-3 are non-limiting examples of how biding, offers, acceptance of offers, counter offers, acceptance of counter offers, and payment may be handled in a needs based auctioning system and various alternative flows may be used. A counter offer by an owner need not be an amount that exceeds the customer original bid amount and in some instances an owner may counter offer with an amount that is lower than the customer's original bid amount. For example, prior to the bid window closing or another owner accepting a bid, one or more of the owner's may submit a counter offer to the customer and the customer may choose to accept only one of the one or more counter offers. However, the one or more counter offers may include one from an owner who wishes to garner the customer's business by submitting a counter offer that is lower than the customer's bid amount (e.g., the owner may attempt to undercut other owners by submitting a lower counter offer for consideration by the customer).

If the YES branch is taken at the stage 308, then flow 300 may transition to another stage in another flow, such as the stage 118 or 218 of flows 100 or 200 as described above. The stage 308 may be transitioned into from another stage in another flow, such as the stage 106 or 206 of flows 100 or 200 as described above. If a YES branch is taken from the stage 310, indicating that an owner has accepted the customer's bid, then flow 300 may transition to another stage, such as the stage 307 where customer funds may be escrowed as described above.

FIG. 4 depicts a block diagram 400 of one example of a needs based auction system. A centralized service 401, such as a web site, web page, bulletin board, URL, URI, etc., for example, may be in communication with data resources including but not limited to data storage 450, external data 451, and cloud 490. The centralized service 401 may be a web site/page operated by a vacation rental service, for example. Data resources that may be accessed by (e.g., for read or write) by centralized service 401 may comprise data including but not limited to information related to listings for purchase, lease or rent, descriptions of listings, availability dates and times for listings, amenities associated with a listing, locations for listings, historical pricing data for listings, historical availability of listings, historical bid prices for listings, data, metadata or other information regarding a likelihood a bid will be accepted, listing costs, seasonality of listings, availability dates for a listing, arbitration of the bidding process, arbitration of the acceptance process, tourist sites near a listing, restaurants/attractions/entertainment/recreation near a listing, number of allowed occupants for a listing, pets allowed or not, smoking allowed or not, available parking for a listing, reviews of listings, deposit amounts for a listing, cleaning fees for a listing, taxes or other fees related to a listing, just to name a few, for example. The data resources may originate from a variety of sources including but not limited to data on listings provided by owners of the listings (e.g., craigslist), realtors, customers, rental management agencies, feedback or other data from customers who have occupied a listing, a vacation rental service, a review service (e.g., Yelp™), a social network (e.g., Facebook™, Twitter™, YouTube™, Pinterest™, Tumblr.™, Google+™, Instagram™, Flickr™, etc.), a professional network (e.g., LinkedIn™), customer reviews, etc. Centralized service 401 may include compute resources 452 and/or may have access to external compute resources through wired and/or wireless communications networks, for example. Although wireless communication (483, 493) is depicted in FIGS. 4-6, wired communications may be used for data communications for the examples depicted herein.

Compute resources that may be accessed by services described herein (e.g., centralized service 401, payment service 408, deal service 801, escrow services, fund transfer services, placing and/or releasing holds on funds, refund services, payment services, financial services, etc.) may include but are not limited to a PC, a laptop, a server(s), a compute engine(s), a computing device(s), client device(s), wireless client device(s), processor(s), smartphone, tablet, pad, etc., just to name a few. The compute resources may be networked using wired and/or wireless communication networks and may be accessed by a call (e.g., a data communication) from one or more of the services described herein. Data communications between the service and the compute resources may be uni-directional (e.g., transmit only or receive only) or bi-directional (e.g., both transmit and receive). Compute resources that may be accessed by services described herein may be configured through hardware, software or both to execute tasks (e.g., algorithms embodied in a non-transitory computer readable medium) in response to information or other data communicated to the compute resource by the service that accesses it. Services described herein may access the same or different compute resources. Compute resources may have access (e.g., via wired or wireless communications networks) to data storage. Furthermore, that data storage may include data storage accessible by the services described herein (e.g., Cloud 490, DS 450, External Data 451, DS 850, DA 804, DS 802, and Internet 890, etc.). Compute resources may be separate, may be the same, or may be shared by one or more of the services described herein.

In block diagram 400, a customer (C) 410 may interface with centralized service 401 via a GUI, dashboard, web page, web site or other menu and/or graphics based system displayed or otherwise presented on a device 412. Device 412 need not be as depicted and may include but is not limited to a PC, laptop, desk top, all-in-one PC, server, PDA, smartphone, tablet, smart watch, a wearable device, touch screen device, cellphone, a terminal, and a smart TV, just to name a few. User device 412, centralized service 401, cloud 490, data storage 450, external data 451 may be in communications with one another using a variety of technologies including but not limited to wireless communication, wired communication, Ethernet, WiMAX, WiFi, cellular, 3G, 4G, optical, fiber optical, or other data communications networks. For purposes of explanation, data communications may be wireless using one or more wireless systems 480 and various components of the block diagram 400 may be in wireless (483, 493) communications with one another.

User device 412 may include a display that displays a GUI or some other form of user interface, and customer 410 may use the GUI to search, browse and make selections for listing on a GUI/dashboard 404 which may not look like the example GUI/dashboard 404 depicted in FIG. 4. User device 412 may include a non-transitory computer readable medium that includes executable program instructions configured to generate the GUI and communicate via 483 the searches, bid amount, bid parameters, listing selections and other data entered by customer 410 using the GUI to the centralized service 401.

As one example, the GUI may be a web based program that is accessed over the Internet by device 412 and the program need not be resident on device 412. Centralized service 401 may also include processing devices and data storage (e.g., such as servers, RAID or the like) that include a non-transitory computer readable medium that includes executable program instructions configured to implement a needs based auctioning system and to communicate with one or more devices such as user device 412. Centralized service 401 may also include a data storage system (e.g., RAID, the Cloud 490, hard disk drives—HDD, solid state drives—SSD, etc.) for data retrieval and storage. The data storage system may include data storage 450. The GUI may be presented as a web page the customer 410 visits to search for and browse listings and to place bid(s) on one or more listings. As one example, prior to using the GUI or other tool, the customer 410 may have access credentials, such as a user name/email address and login or may have to register and obtain the user name/email address and login as denoted by 402. In other examples, access to the GUI or other tool may be via either a guest login or no login required at all.

For purposes of explanation, assume the customer 410 has access to the needs based auction system (e.g., via centralized service 401) and is now presented with the example GUI 404. Here, the customer 410 may wish to secure a listing at a location for a given period of time and at a bid price the customer 410 is willing to pay. To that end, GUI 404 may include several icons, drop down menus, radio buttons, and search fields etc., aimed at assisting the customer 410 in finding and biding on listings that meet the user's criteria. The content/information depicted in GUI 404 is just an example and the GUI 404 may include more, less, or different content/information than depicted. Content in GUI 404 may comprise icons, drop down menus, etc. and information in GUI 404 may include displayed search results for listings based on search criteria entered by the customer 410, for example. Search criteria and other data may be saved by user 410 for future interactions with the centralized service 401.

Using GUI 404, or an equivalent interface, customer 410 may input an “Arrive” date (e.g., check-in date) and/or time and a “Depart” date (e.g., check-out date) and/or time for a stay at a listing. For example, the “Arrive” date and/or time may be Friday, Jun. 28, 2013 at 3:00 pm EST and the “Depart” date and/or time may be Sunday, Jun. 30, 2013 at 12:00 pm EST. Customer 410 may then enter search criteria for listings in a “Listings Search Data” field. The “Listings Search Data” field may allow the customer 410 to enter a variety of information (e.g., search parameters) to locate listings suitable to the user's objectives including but not limited to: City, State, Country, Street, Address, County, number of bedrooms, types of beds (e.g., Twin, Queen, King, etc.), number of bathrooms, bathroom accommodations (e.g., bath tub, shower, bidet, etc.), parking spaces, fireplace, swimming pool, sauna, Jacuzzi, hot tub, proximity to an attraction (e.g., a beach, entertainment), kitchen facilities, pets allowed, smoking allowed, maximum occupancy, other amenities, etc., just to name a few.

After entering the search parameters for listings, the customer 410 may click an “ENTER” icon (e.g., GO, Search) to initiate the search for listings that meet some or all of the parameters selected by the customer 410 and those listings may be displayed in a “Search Results” window. Here, for purposes of explanation, customer's 410 search returned results for listings denoted as L1, L2, L3, . . . Ln. The actual number of listings may be more or fewer than depicted. Each listing may include text, a hyperlink, or other information specific to that listing as denoted by 444. Furthermore, each listing may include a checkbox “ [symbol] ” 444c that the customer 410 may check “ [symbol] ” 444d in order to have a bid from the customer 410 be communicated to an owner of the checked listing as will be described below. Customer 410 may peruse the search results and data 444 for each listing and decide on which listing to place a bid on. Here, customer 410 has selected, by checking the check boxes 444d, listings L1, L2, L7, L8 and Ln to place a bid on. In some examples, the customer 410 may choose to not select any of the listings presented in the “Search Results” window. Therefore, dashed arrow 433 depicts an instance where the customer 410 may make a decision “?” to retry 435 the process (e.g., with new search parameters) or to “END” 437 the process.

Assuming for purposes of explanation that the customer 410 has made the above selections of listings L1, L2, L7, L8 and Ln and wishes to place a bid or bids on one or more of the listings, GUI 404 may include a field for the customer 410 to input a bid amount denoted here as “BID Amount $$”. The customer 410 may type in (e.g., using a keyboard, stylus, finger, etc.) a bid amount or amounts to be presented (e.g., via an email, SMS, or text message) to the owners of the selected listings L1, L2, L7, L8 and Ln. Here, customer 410 may choose to enter a bid amount of $630 for a stay at one of the selected listings. Moreover, the bid amount may be considered as an offer that if accepted by one of the owners of the selected listings, creates a biding legal contract between the customer 410 and the owner. Furthermore, the customer 410 may choose to select a window during which the offer is capable of being accepted denoted here as “BID Window”. An offer accepted by one of the owners within the “BID Window” may invoke the aforementioned binding contract between customer 410 and the accepting owner. As one example, the “BID Window” may be set by the customer 410 in units such as time (48 hours) or days (1 day), or some other temporal unit of measure. If the customer 410 does not enter data for the “BID Window”, then a default “BID Window” may be implemented (e.g., by centralized service 401) such as a default “BID Window” of 24 hours. After the “BID Window” closes (e.g., has expired) the offer by customer 410 in the amount of $630 has expired and is no longer capable of being accepted by any of the owners of the selected listings. As described above in reference to flow 200 of FIG. 2, in some examples, the customer 410, using GUI 404 may submit different bid amounts for the selected listings L1, L2, L7, L8 and Ln, such as $630 for L1, $650 for L2, $700 for L3, $590 for L7, etc., for example.

After the customer 410 has entered the “BID Amount $$” the GUI 404 may include a submit field denoted as “Submit BID for $$”. By clicking on or otherwise activating the “Submit BID for $$” button, the customer 410 may be offered or otherwise directed 417 to a payment screen 406 designed to facilitate the entry of payment information by the customer 410 to tender payment the “BID Amount $$” (e.g., $630 or the highest bid amount if multiple bid amounts are submitted for multiple listings). Payment screen 406 may include fields for the amount bided “BID Amount $$”, credit card number, credit card expiration date, credit card verification number “CVN”, name on the credit card, and billing address for the credit card, for example. Customer 410 may enter the information in the various fields and then click on or otherwise activate a “CONFIRM” icon/button on the payment screen 406. In some examples, the payment screen 406 may include fields for bank account information (not shown) such as routing number, account number, name of bank, etc. so that the customer 410 may choose to have the funds for the “BID Amount $$” debited from a bank account instead of a credit card/debit card account. Payment screen 406 may include fields for credit card information, bank account information, or both. Payment screen 406 may include fields for electronic payment of the “BID Amount $$” using a service such as PayPal™ or other, for example.

In yet another example, payment screen 406 may include fields for a “3^{rd} Party Payment” provider (e.g., PayPal™ or the like). If the customer 410 chooses to tender the “BID Amount $$” via the “3^{rd} Party Payment” route, then the customer 410 may click or otherwise activate the “3^{rd} Party Payment” icon and may be directed 421 to a screen for a 3^{rd} party payment service 408, where the customer 410 may be required to login using a user name/email address or and a password as denoted by “Customer Login”. After logging in (if access credentials are required) the customer 410 may enter whatever information is required by the 3^{rd} party payment service 408 and then may click or otherwise activate an icon to “Confirm Payment for BID Amount $$”. After confirming payment, the 3^{rd} party payment service 408 may redirect 423 the customer 410 back to the payment screen 406. Here, upon being redirected 423, the funds $$ for the “BID Amount $$” are now available to consummate the transaction (e.g., centralized service 401 has funds from customer 410 in the amount of the bid). On the payment screen 406, the customer 410 may click or otherwise activate a “CONFIRM” icon and the funds, regardless of the source (e.g., credit card, bank account, 3^{rd} party payment, or other) are placed 419 on HOLD 408 in anticipation of an owner of one of the selected listings accepting the offer within the “BID Window” as described above. Moreover, the funds on HOLD 408 may be placed into escrow as described above. Payment service 408 may include internal and/or external compute resources.

Dashed arrows 427 and 429 depict a scenario in which the funds on HOLD 408 are released to an account of the owner of one of the selected listing who accepted the offer from customer 410 before any of the other owners and before the “BID Window” had closed. One condition for release of the funds to the accepting owner may be the customer 410 taking occupancy 416 of the listing (e.g., possession of leasehold). The funds on HOLD 408 may be electronically transferred to an account of the accepting owner 418. In some examples, the release of funds 408 may occur on the “Arrive” date or on the “Depart” of the customer 410, or somewhere in between those dates, for example.

Alternatively, the transaction (e.g., the deal) may fall through before the customer takes occupancy 416 for a variety of reasons including but not limited to the owner or customer 410 backs out, the listing is destroyed, uninhabitable, or otherwise unavailable, customer 410 becomes ill or is unable to occupy the listing for whatever reason. In the event the transaction falls through, dashed arrow 431 depicts a scenario where the funds on HOLD 408 are released or refunded 414 to the customer 410. The full amount or only a portion of the funds on HOLD 408 may be refunded/released 414 to the customer 410. In other examples, if the transaction falls through, the funds on HOLD 408 may still be released 418 to the owner. Examples include but are not limited to the customer 410 not cancelling his/her reservation for the listing within a specified notice period, the customer 410 failing to take occupancy for the dates agreed upon, just to name a few.

In some examples a customer 410 may not use or have access to a user device 412 and may wish to use some other means by which to place a bid for one or more listings. Customer 410 may telephonically contact 461 a customer service representative (CS) 415 (e.g., by dialing a number such as 1-800-YYY-WWWW, using a landline phone, VoIP, Skype™ or other service). CS 415 may use a device 460 (e.g., a laptop PC, desk top PC, server, or the like) to access 465 the GUI 404 or other interface. Here, CS 415 can listen 463 to customer 410's needs and requirements for a listing and use the GUI 404 or other interface to input the information and data described above to find suitable listings, select listings the customer 410 has instructed the CS 415 to bid on, and enter a bid amount specified by customer 410. The GUI used by CS 415 may be identical, similar, or different than the GUI 404. CS 415 may also handle the collection of funds from the customer 410 for the “BID Amount $$” by submitting the customer's bid and using the payment screen 406 or other payment system to obtain the customer's credit card or bank account info and then make the necessary withdrawal of the funds which are then placed on HOLD 408 as described above. CS 415 may be in communication 483 with centralized service 401 via device 460 which may display a GUI that allows CS 415 to enter the information from customer 410 and place the bid for the listings the customer 410 instructs CD 415 to select. CS 415 may or may not be able to process payment of funds from customer 410 using the 3^{rd} party payment service 408. In some examples, CS 415 may not be a human being and may be an automated system for interacting with customer 410 (e.g., using voice prompts). After CS 415 activates the “CONFIRM” icon, processes that may occur after that may be as described above.

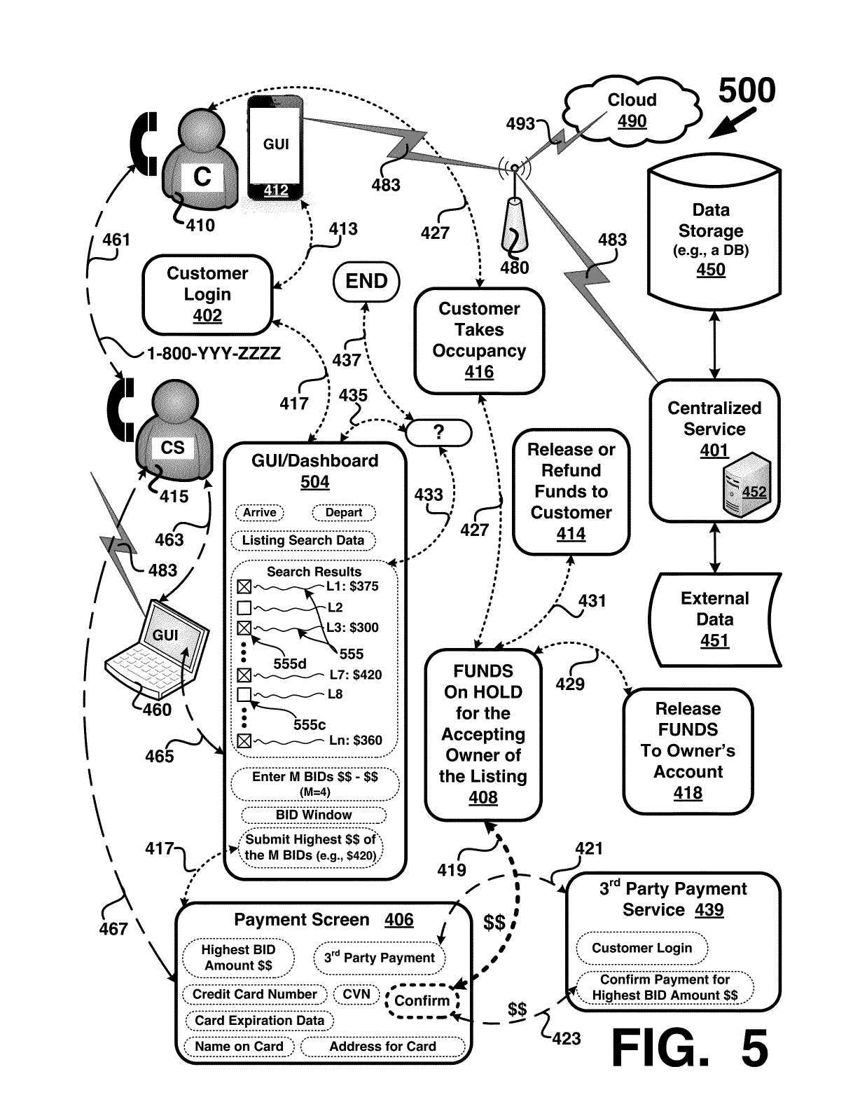

FIG. 5 depicts a block diagram 500 of another example of a needs based auction system. Unlike, block diagram 400 of FIG. 4 where the customer 410 enters a single bid amount for one or more listings L, block diagram 500 depicts an example of a GUI 504 in which the customer 410 enters M bids for N listings as described above in reference to FIG. 2. Key differences between diagrams 400 and 500 may include “Search Results” in diagram 500 that have N listings denoted as L1-Ln and different bid amounts for at least two of the N listings. Each listing may have associated information 555 and a checked “ [symbol] ” 555d box or un-checked “ [symbol] ” 555c box adjacent to it. In the example depicted, the customer 410 has selected four of the listings (L1, L3, L7 and Ln) to bid on denoted by the four checked boxes and customer 410 has entered four different bid amounts for each of the four selected listings as follows: L1=$375; L3=$300; L7=$420; and Ln=$360. The customer 410 may enter the same bid amount for some of the four listings (not shown) as follows: L1=$350; L3=$350; L7=$420; and Ln=$360 or L1=$425; L3=$425; L7=$425; and Ln=$360. Software or the like may reject an incorrect placing of M bids by the customer 410 as follows: L1=$375; L3=$375; L7=$375; and Ln=$375, because at least two of the M bid amounts must be different and all four of the amounts in this example where M=4 are the same. Returning back to the first example where L1=$375; L3=$300; L7=$420; and Ln=$360, where M=4, the customer 410 may use an icon “Enter M BIDs $$-$$”, to enter the desired amounts for each of the selected listings L1, L3, L7, and Ln. After entering the M bids, the customer 410 may be prompted to submit the highest priced bid of the M bids (e.g., L7=$420) by an icon “Submit Highest $$ of the M BIDs” and upon activating or clicking on that icon be directed to the payment screen 406.

Tendering payment for the highest priced bid of the M bids is not much different from that described in diagram 400; however, in diagram 500 the amount displayed on the payment screen 406 is “Highest BID Amount $$” and represents the $420 the customer bid for listing L7 in the example depicted. On the other hand, if the highest bid for the N listings was $721, then payment screen 406 would present that amount ($721) to the customer 410 as the amount that will be debited from the customer's account and placed on HOLD 408 after the customer 410 clicks or otherwise activates the “Confirm” icon as described above. Here, the customer 410 may use the 3^{rd} party payment service 439 or may use a bank account (e.g., checking account) instead of a credit card as described above in reference to diagram 400.

In diagram 500, the tendered funds are place on HOLD 408 and the first owner of the N listings to accept the amount bided for his/her listing before the “BID Window” closes is the accepting owner and the amount bid on the accepting owners listing is released 418 to that owners account. For example, if the owner of listing L1 is the first owner to accept, then $375 of the $420 on HOLD 408 is transferred to the account of the owner of L1. If the amount bid for L1 is less than the amount on HOLD 408, then the difference between the bid amount and the amount on hold may be refunded to the account of the customer 410 (e.g., $420−$375=$45). In the event a refund is required, dashed arrow 431 depicts a scenario where a portion of the funds on HOLD 408 are released or refunded 414 to the customer 410. As described above, if the transaction (e.g., the deal) falls through, nothing precludes another refund of any funds that are due to the customer 410, such as the bid amount of $375 for listing L1.

In some examples, after a customer 410 has submitted a single bid for N listings (e.g., FIGS. 1 and 4) or has submitted M bids for N listings (e.g., FIGS. 2 and 5), at least one owner may make a counter offer to the customer 410 for a price that is different than the price the customer bid for that owner's listing. Typically, an owner may counter offer with a price that is higher than the bid price, but an owner may also counter offer with a price that is lower than the bid price, or may counter with different bid parameters as described above.

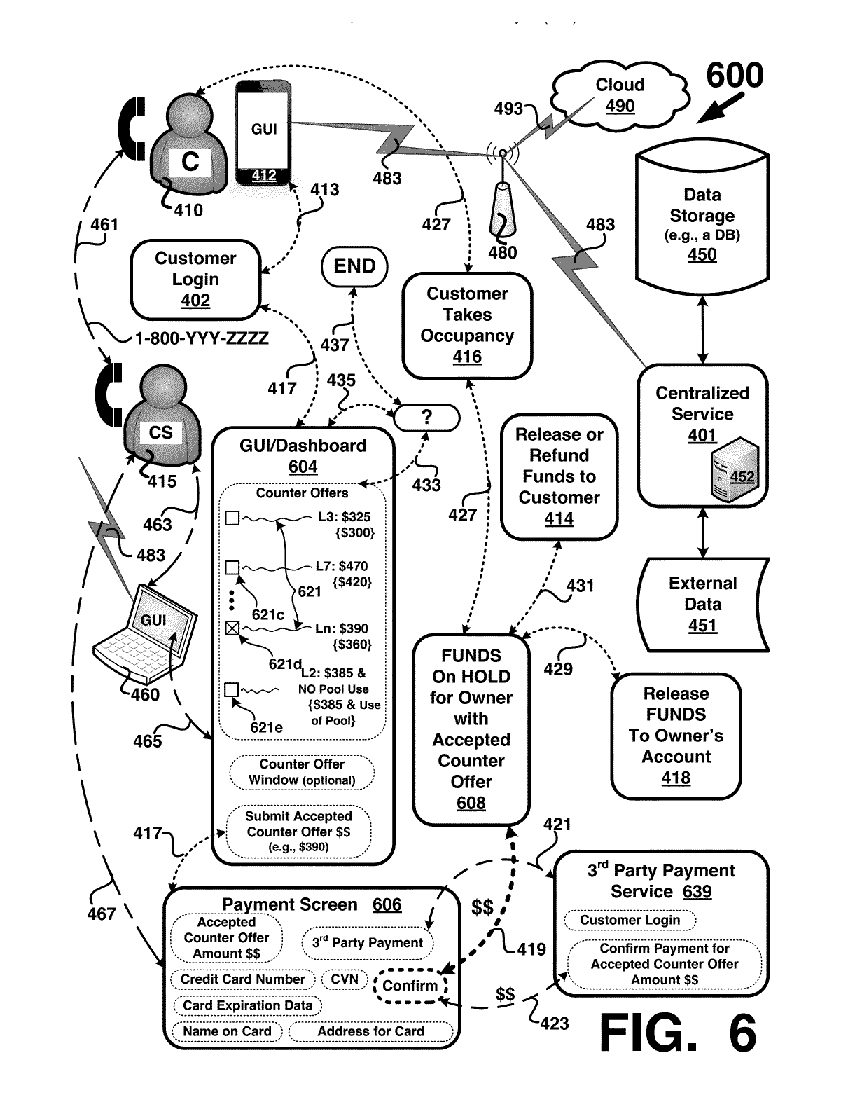

FIG. 6 depicts a block diagram 600 of one example of counter offer handling. For purposes of explanation assume that customer 410 has already placed a bid or bids according to the examples depicted in FIG. 4 or FIG. 5. Also assume for purposes of explanation that the “BID Window” has not closed and no owner has accepted a bid from customer 410. Customer 410 may receive on user device 412 one or more counter offers from one or more owners of listings the customer 410 has placed bids on. The one or more counter offers may be displayed on a GUI 604. Here, customer 410 has received three counter offers for listings L3, L7, and Ln in the amounts of: L3=$325 {$300}; L7=$470 {$420}; and Ln=$390 {$360}, with the customer's 410 original bid amounts shown in “{ }”. The one or more counter offers may optionally be presented to the customer 410 with a “Counter Offer Window” in which the customer 410 must accept one of the counter offers or the counter offers expire when the “Counter Offer Window” closes (e.g., after 8 hours). If there is a conflict between the “Counter Offer Window” and the “BID Window”, then the running of the “BID Window” may control, that is, closing of the “BID Window” supersedes closing of the “Counter Offer Window”. For example, if the “BID Window” was set to 24 hours and during those 24 hours one or more counter offers are received, then those counter offers are rendered moot if the “BID Window” closes before the customer 410 has accepted one of the counter offers.

In the example depicted, the counter offers may include information 621 associated with each counter offer (e.g., terms and conditions) and associated boxes (e.g., 621c) for the customer to check to accept only one of the counter offers presented as denoted by a checked “ [symbol] ” 621d box for counter offer amount $390 from the owner of listing Ln. Acceptance by customer 410 of the counter offer of $390 for listing Ln may transfer 417 the customer 410 to a payment screen 606 where payment is tendered and placed on HOLD 608 as described above for diagrams 400 or 500; however, in the case of a counter offer, the amount tendered by customer 410 may be the accepted counter offer amount. In that the customer 410 may already have funds on HOLD (e.g., 408) from the examples depicted in diagrams 400 or 500, the acceptance of the counter offer may result in a second transaction for the amount of the accepted counter offer (e.g., $390) or for the difference between the original bid amount and the accepted counter offer amount (e.g., $390−$360=$30). For example, if the $360 for listing Ln has already been placed on HOLD 408, then the those funds may be refunded/released 414 back to the customer 410 and a new HOLD 608 placed on the funds of customer 410 for the $390 counter offer amount accepted by the customer 410.

As another example, if the $360 for listing Ln has already been placed on HOLD 408, then the those funds may remain on HOLD 408 and an additional HOLD 608 for $30 may be placed on the funds of customer 410 to make up the difference between the original bid amount $360 and the accepted amount of $390 for the counter offer. GUI 604 also depicts a scenario where an owner makes a counter offer on a bid parameter. For example, if customer 410 requested use of a swimming pool for listing L2, then the owner for L2 may counter offer by changing the bid parameter from {“Use of Pool”} to “No Pool Use”. If the customer 410 had checked box 621e “□” next to the counter offer for L2 instead of the box 621d for listing Ln, then the original bid amount for listing L2 (e.g., $385) would be accepted along with an acceptance of the owner's counter offer that modified the bid parameter to “No Pool Use”.

The customer 410 taking occupancy 416 may result in all funds due the owner of the listing to be released 418 to the owners account and/or all funds due back to the customer 410 being released/refunded 414 to the customer 410. Diagram 600 may encompass a scenario where CS 415 contacts 461 the customer (e.g., telephonically) to present one or more counter offers for the customer 410 to consider and potentially accept, verbally (e.g., over the phone) or otherwise (e.g., using device 412). CS 415 may have displayed on device 460 identical, similar, or different counter offer information 465 depicted in GUI 604 to use in aiding customer 410 in considering and potentially accepting a counter offer.

In some examples a bid amount may comprise an amount(s) offered by customer 410 for purchase of real property (e.g., in fee simple absolute) from one or more owners. A counter offer may comprise a higher or lower purchase price submitted by one or more of the owners and/or may comprise modification of a bid parameter by one or more of the owners. For example, customer 410 may offer $850,000 for one or more properties and one or more owners of those properties may be the first to accept the bid amount of $850,000 or, prior to a first acceptance by any owner, another owner may counter offer with a higher price (e.g., $879,000) or a lower price (e.g., $845,000) for example. The customer 410 may have set a bid parameter of “Property to be In Move in Condition”, and one of the owners may counter offer with “Property SOLD AS IS”, for example. As described above, the customer 410 may bid different bid amounts for a plurality of different properties. The holding and escrow of funds may occur as described above, or may be modified when customer 410's offer comprises an offer to purchase real property. For example, the amount place on HOLD may be a percentage of the accepted purchase price of the property (e.g., a down payment of 10-20% of the $850,000 bid amount). Future actions relative to the property may include placing a remainder of the funds necessary to meet the purchase price into an escrow account (e.g., via a title company or the like) until a final closing for the purchase of the real property occurs.

The flows 100-300 and the examples 400-600 as described above may be modified to switch roles of customers and owners. For example, instead of customer 410 submitting bid amounts and optionally bid parameters to owners, one or more owners may submit bid amounts (e.g., offers to rent, lease, or purchase property at some specified price) and optionally bid parameters to one or more customers, who may timely accept within the bid window the offer from one of the one or more owners, and/or who may timely counter offer the bid amount and/or bid parameters to one of the one or more owners. Centralized service 401 may connect owners desiring to sale, rent or lease property with customers desiring to purchase, rent or lease property, for example. Centralized service 401 may maintain and/or have access to a data base or other form of data store that may include profiles or other data on customers and/or owners, and that data may be used to submit data from interested owners to potentially interested customers. For example, based on a history of prior transactions, customers may have made bids on property for lease in the Lake Tahoe area of California. Subsequently an owner or owners of a property in Lake Tahoe may wish to rent, lease or sale their Lake Tahoe property and may use a dashboard or other GUI similar to that depicted in FIGS. 4-6 to submit offers to customers whose prior history indicates interest in properties in the Lake Tahoe area. Here a single owner may submit offers to one or more customers or a plurality of owners may submit offers to one or more customers, for example. A third party (interested or disinterested) may act on behalf of owners or customers (e.g., a real estate agent, a booking agent, a vacation rental agency, a rental agency, a home owners association, etc.).

In some examples, customers and owners may conduct an entire course of a transaction using a client device, such as a wireless client device (e.g., a smartphone, tablet or pad), with the central service 401 using its processing, data storage, and data communications resources to connect customers with owners and act to consummate the transactions as described above. An application (APP) such as those that may be downloaded/installed from an APP store (e.g., the App Store™, Google Play™ store or the like) may execute on the client device to effectuate barter between customers and owners until a transaction is consummated (e.g., an agreement between customer and owner is reached) or is abandoned for lack of customers and owners reaching a mutual agreement to terms (e.g., acceptance of bid amount and/or bid parameters or acceptance of a counter offer).

In other examples, if a customer submits a single bid price to a plurality of owners or multiple bid amounts to a plurality of owners, each owner may have visibility to the total number of owners the customer's bids were submitted to and the bid prices that were submitted to the other owners. For example, customer may bid $900 for a five day stay at six listings owned by six owners. Each of the six owners may not only receive the bid amount and days of stay but also be apprised there are five other owners who may accept the bid. One or more of those six owners may decide to counter offer with a lower price (e.g., $850 for the five-days or $900 for six days of stay, etc.) As another example, if the customer bids $450, $425 and $410 for three listings owned by three owners, each owner may be apprised there are two other owners the customer has submitted bids to. In some examples, each of the three owners may know of the bid amounts submitted to the other two owners and may use that information to decide to accept the bid, ignore the bid, or make a counter offer on the bid. However, actual owner information or specific information about the listings of those owners (e.g., listing address) may not be revealed to the owners who receive bids from the customer. On the other hand, general geographic information may be presented to the owners, such as all three listings bid on by the customer are in a specific zip code, postal code, neighborhood, vacation spot, or are in the same region (e.g., Napa, Calif. or Aspen, Colo., etc.). An ability of an owner to see other listings in contention for accepting the customer's bid may create a sense of urgency that may motivate owners to accept bids or make timely counter offers. Historical information on the number of bids an owner has accepted in the past and prices or average prices for accepted and/or rejected bids may be shared with other owners, with the customer submitting the bid, or both.

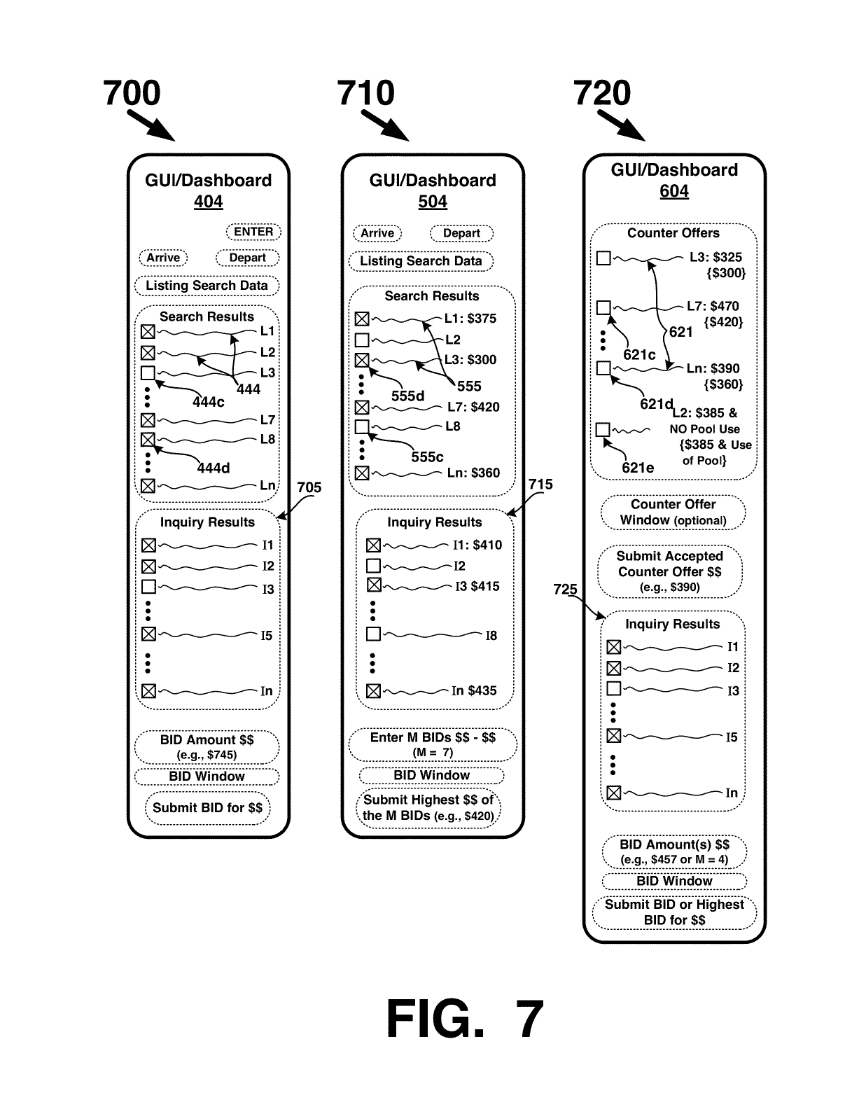

Attention is now directed to FIG. 7 where examples 700-720 of inquiry bids in a needs based auction system are depicted. The user interfaces described above in reference to FIGS. 4-6 may be modified to include additional information that is presented to a customer and/or an owner. In example 700 the customer may have already searched for listings that meet the customer's needs and may have already placed a bid (e.g., $745) for those one or more listings (e.g., the five checked “ [symbol] ” listings) presented in “Search Results”. To aid the customer the centralized service 401 or other system may optionally present additional listings 705 that may meet the customer's needs (e.g., based on search criteria, geographic location, availability dates, historical data, historical data on bid amounts accepted by owners of listings, bid parameters, etc.) and denoted as “Inquiry Results”. Here, example 700 depicts inquiry results I1-In. The customer may click on (e.g., using a mouse, stylus, finger, touch screen, touch pad, etc.) one or more of the listing (I1-In) in the “Inquiry Results” and make a determination as to whether or not to place a bid on any of those listings. In the example 700, the customer has selected four listings (I1, I2, I5 and In) to place bids on. The bid amount may be the same as for the selected listing in “Search Results” (e.g., $745). Therefore, in total, the customer has selected nine listings to bid on (L1, L2, L7, L8, Ln, I1, I2, I5 and In) and those bids may be transmitted to the owners of those listings as described above in reference to FIGS. 1-6.

In example 710, additional listings 715 may also be selected by a customer and each selected listing (I1-In) in the “Inquiry Results” may have a different bid amount entered for it as was described above in reference to FIGS. 2 and 5. Here, the customer has selected three listings (I1, I3 and In) to place bids on and the amounts of the bids may be different for the three listings selected (e.g., I1: $410; I3: $415; In: $435). Therefore, in total, the customer has selected seven listings to bid on (L1, L3, L7, Ln, I1, I3 and In) with different bid amounts for the seven selected listings, and those bids may be transmitted to the owners of those listings as described above in reference to FIGS. 1-6.

In example 720, additional listings 725 may also be selected by a customer as part of the customer's calculus of decision regarding receiving a counter offer from one or more owners of listings. Owner(s) may have submitted counter offers as to bid amount and/or bid parameters as described above in reference to FIGS. 3 and 6. The customer may be adverse to counter offers, annoyed by the additional barter associated with a counter offer or may just want the transaction for obtaining one of the bid upon listings to be as simple and hassle free as possible. Therefore, the additional listings 725 provide the customer with another opportunity to bid on listings that may meet the customer's needs based on the data the customer entered for the listing(s) associated with the counter offer(s). Here, listing (I1-In) are presented to the customer in the “Inquiry Results” and the customer has selected four listings to bid on (I1, I2, I5 and In). The bid amount may be the same for all four listings or may be different for all four listings as described above in reference to FIGS. 1-2 and 4-5. In some examples the initial format the customer used to place bids may control, such that is a single bid amount was place for N listings, then in example 720 a single bid amount will apply to selected listings (I1, I2, I5 and In) in the “Inquiry Results”; on the other hand, if M bids were placed for N listings, then in example 720 different bid amounts may be applied to selected listings (I1, I2, I5 and In) in the “Inquiry Results”. In other examples, the customer may choose to place a single bid amount on the selected listings (I1, I2, I5 and In) in the “Inquiry Results” or may choose to place different bid amounts on those selected listings.

In example 720 acceptance of a counter offer may nullify or prevent selection of listings in the “Inquiry Results”. Here, in that none of the counter offer listings has a checked “ [symbol] ” box next to it, the customer is enabled to select one or more of the listings 725 in the “Inquiry Results”. If the customer selects both a counter offer and one or more listings 725 in the “Inquiry Results”, then the system may prompt the user (e.g., in a field of GUI/Dashboard 604 to choose either the counter offer or one or more of the listings 725 in “Inquiry Results”, but not both.

In examples 700-720, the “Inquiry Results” may be selected and bid amounts entered for the selected listings so long as the bid window has not expired, no offer has been accepted, or no counter offer has been accepted. In some examples the bid window may continue to run down to its previously set termination time such that if the bid window was initially set to 24 hours, and the inquiry bids in 705, 715 or 725 are submitted approximately 12 hours later, then owners of listings selected in 705, 715 or 725 will have approximately 12 hours to accept before the bid window closes. In other examples, the bid window may be reset to a new value to allow all owners of listings to have the same amount of time to accept a bid if they so choose. Therefore, if the bid window was initially set to 24 hours, and the inquiry bids in 705, 715 or 725 are submitted approximately 12 hours later, then the bid window may be reset to 24 hours so owners of all listings selected in “Search Results” and “Inquiry Results” may have the same amount of time to consider bids. Although owners of listings in “Search Results” have already had 12 hours of the initial 24 hours to consider bids, lack of acceptance at the time the customer selected and bid on the “Inquiry Results” may place all listing owners on equal footing. As was described above, all owners of all listings selected by the customer may have some visibility as to the number of listings bid on, geographic information, bid ranges, bid amounts, etc. Resetting the bid window along with the information that additional listings (e.g., from “Inquiry Results”) are being bid on by the customer may serve to motivate the owners of listings from “Search Results” to accept, counter offer, or ignore the bid amounts/bid parameters they received given the increased competition from the additional listings. Presenting additional listings in the “Inquiry Results” may be useful in situations where the listings selected in “Search Results” are in high demand (e.g., in a popular vacation destination) and presentation of “Inquiry Results” that may meet the customer's needs may provide more certainty that the customer may have a bid accepted by an owner from a larger pool of listings. As before, the customer may wish for certainty in obtaining a listing at a bid on price for a specified data range and an owner may wish for certainty in receiving prompt payment for the accepted amount.

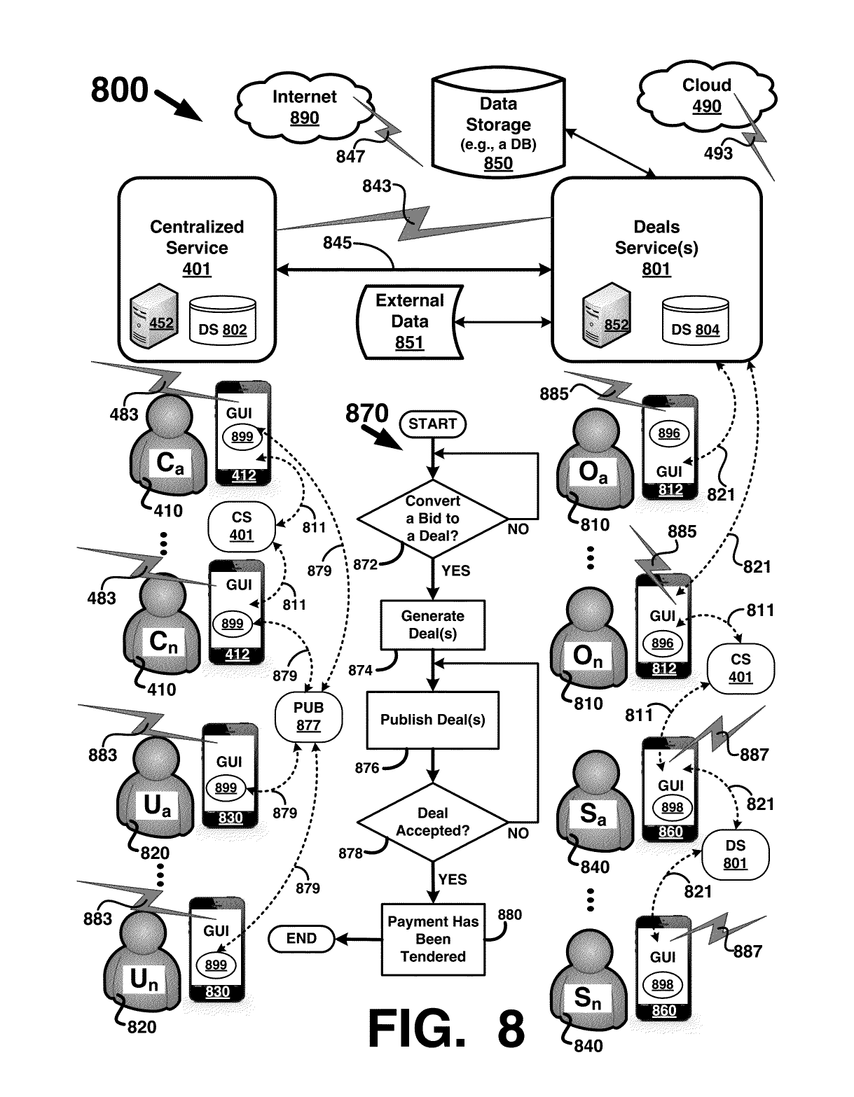

Moving on to FIG. 8 where an example block diagram 800 and an example flow chart 870 for converting bids to deals are depicted. In FIG. 8 one or more customers 410 (Cₐ-Cₙ) may have placed bids on one or more listings using centralized service (CS) 401 as described above in reference to FIGS. 1-7. Moreover, one or more owners 810 (Oₐ-Oₙ) may have received offers for the bid amounts from the one or more customers Cₐ-Cₙ via CS 401. Here, customers Cₐ-Cₙ and owners Oₐ-Oₙ may be in communication 811 with CS 401 and may interact with CS 401 to perform tasks including but not limited to browsing listings, selecting listings to bid on, selecting bid amounts for listing, accepting bids, rejecting bids, making counter offers, reviewing offers, reviewing counter offers, rejecting counter offers, reviewing inquiry bids, rescinding bids or bid amounts, etc. Each of the owners Oₐ-Oₙ may review bid offers they receive and may decide whether or not to act on those offers by accepting them, rejecting them, or making a counter offer on them. However, one or more of the owners Oₐ-Oₙ may decide to convert one or more bid offers to a deal offer that may be communicated to one or more of the customers Cₐ-Cₙ and may also be communicated to additional users 820 (Uₐ-Uₙ) who may or may not have a relationship with CS 401 and who may not have placed any bids at all. Optionally, additional sellers 840 (Sₐ-Sₙ) who may or may not have a relationship with CS 401 and who may not have receive any bid offers at all may also generate deal offers that may be received by one or more of customers Cₐ-Cₙ and/or additional users Uₐ-Uₙ. Here users Uₐ-Uₙ may be customers and additional sellers Sₐ-Sₙ may be owners; however, their nomenclature has been changed to prevent confusion with those entities that are associated with CS 401 (e.g., via registration, enrollment, access credentials, user name and password, contract, placing of bids on listings, accepting bid offers, counter offers, recipients of inquiry bids, etc.).

The following are non-limiting examples of conversion of bids to deals and example rationales that may motivate an owner to convert a bid to a deal. As a first example, assume one or more owners Oₐ-Oₙ associated with CS 401 receive bid offers from at least one customer Cₐ-Cₙ associated with CS 401, and the bid comprises one or more bid prices with specified stay dates for the selected listings (e.g., three nights). Now, one or more of the owners (e.g., Oₐ) may not be interested in haggling back-and-forth with customer(s) (e.g., Cₐ) who submitted bids (e.g., by way of counter offer as to bid amount and/or bid parameters). Instead, owner Oₐ may wish to convert the bid he/she received to a deal for a set price that owner Oₐ wants for his/her listing and for a specified date range owner Oₐ wants to make the listing available for occupancy by a customer. For instance, if a bid offer submitted by customer Cₐ and received by owner Oₐ is $575 for a three-night stay at the listing beginning on Mar. 15, 2015 and ending on Mar. 19, 2015. Owner Oₐ may want to fetch a higher price for the listing for the specified date range because it may be a season of the year where demand for stays at the listing is highest. Therefore, instead of bartering back and forth with customer Cₐ as to price, owner Oₐ may elect to convert the bid to a deal with a fixed deal price and fixed stay range and then may have that deal published to one or more potential customers who may or may not be associated with CS 401. Further to this example, the bid converted to a deal by owner Oₐ may look like the following example: “South by Southwest® 2015: Nice two bedroom, two bath Condo, in Austin, Tex., one-half mile from SXSW® 2015-$985 for Three-Night Stay beginning Mar. 16, 2015 and ending on Mar. 20, 2015, Accept this Deal NOW by clicking here!”

A conversion of a bid to a deal may not include identical terms as the bid the owner received. A deal may differ in price, stay dates, and may modify bid parameters that were included with the bid. In some examples a bid converted to a deal may not include some or all of the bid parameters (e.g., Use of Garage for Parking) that were submitted with the bid. In the above example, owner Oₐ has elected to convert the bid to a deal having differences in price ($985 vs. $575) and stay dates (Mar. 16, 2014-Mar. 20, 2014 vs. Mar. 15, 2014-Mar. 19, 2014). Here, owner Oₐ may be motivated to garner the highest price for the condo during a peak season (e.g., the occurrence of a festival) when demand for listings to stay at may exceed the available supply of listings.

In an alternative example, owner Oₐ may be motivated to reduce the listing price during times of low demand and may convert a bid to a deal that offers the listing at a price lower than the bid price. Here, by offering a deal, that deal may be published to a larger audience of customers than the pool of customers who submitted bids via CS 401. Therefore, a deal geared towards occupancy of owner Oₐ's listing during an off season may look like the following example in response to a bid for $575 for a four-night stay: “Nice two bedroom, two bath Condo, in Austin, Tex., Close to major attractions-$465 for a Four-Night Stay beginning Jun. 6, 2014 and ending on Jun. 10, 2014, Accept this Deal NOW by clicking here!”.

In the above examples, anyone who received the deal may be the first to accept the deal by taking the “clicking here” action. Upon performing the “clicking here” action, the accepting customer may be directed to or otherwise transferred to a payment screen, web page, dashboard or other form of user interface to immediately tender payment (e.g., swipe credit/debit card, PayPal®, enter credit/bank account information in data fields, etc.). Consummation of the deal by accepting the deal may benefit owner Oₐ by obtaining occupancy of his/her listing while also receiving payment from the customer, and from a perspective of the customer, acceptance of the deal and payment for the deal may provide some certainty that on the agreed upon stay dates the listing will be available for occupancy and is paid for. As mentioned above, the customer who accepts the deal may not necessarily be a customer associated with CS 401 (e.g., Uₐ-Uₙ).

Deals generated by DS 801 may take a variety of forms that may be perceived (e.g., visually, audibly, or via other senses) by the customer and may include but are not limited to text, graphics, icons, audio, video, audio and video, animation, scrolling messages, text message, email, SMS, instant message, voice mail, ad on web page, ad on a website, ad in a web browser, ad in an application (APP) running on a device the customer is using, a tweet, etc. A deal 899 may be published 879 on a screen of a device a customer is interacting with while reading email, browsing the Internet, running an application on a device (e.g., a smartphone, smart watch, laptop, PC, wearable electronics, pad or tablet). Client devices (412, 830) are non-limiting examples of a media that a deal 899 may be published 879 on (e.g., presented via a GUI or other to a customer for consideration) by a publisher (PUB) 877 in communication with client devices (412, 830). For example, client devices (412, 830) may be wireless devices in wireless communication with PUB 877 (e.g., via the Internet 890) and deal 899 may be included with other content being wirelessly transmitted (483, 883) to client devices (412, 830). As one example, deal 899 may be published 877 with content on a social networking or professional networking web site, web browser, or an email site (e.g., Facebook, LinkedIn, Gmail, Amazon, etc.).

Deal service 801 may be in communication (843, 845) with CS 401 and may access or receive data related to bids from one or more customers Cₐ-Cₙ that have been received by one or more owners Oₐ-Oₙ. Deal service 801 may include compute resources 852 and data storage (DS) 804 and may communicate with external sources such as data storage 850, Cloud 490, Internet 890, and external data 851. Compute resources 852 may be internal and/or external to deal service 801. One or more of those external sources may be used by DS 801 to determine which customers (Cₐ-Cₙ, Uₐ-Uₙ) may comprise likely candidates to receive deals from owners (Oₐ-Oₙ, Sₐ-Sₙ) based on a variety of criteria such as browsing activity, searches, historical data, purchasing patterns or other activity of customers (Cₐ-Cₙ, Uₐ-Uₙ). Customers (Cₐ-Cₙ) associated with CS 401 that made bid offers may automatically be selected to receive deals 899. Owners (Oₐ-Oₙ) associated with CS 401 may compose their deal offers 896 for submission to DS 801 and owners not associated with CS 401 may compose their deal offers 898 for submission to DS 801. Deal offers (896, 898) may be generated by client devices (812, 860) that are in communication with DS 801. CS 401 and DS 801 may communicate with each other and share data as necessary to resolve conflicts between owners and customers. As one example, if an owner converts a bid offer to a deal, CS 401 may automatically prevent that owner from accepting the bid offer from the customer in the event the deal 899 is accepted by the customer. In other examples, a deal 899 may be temporally or geographically (e.g., different stay dates, different geographic locations) non-conflicting with the bid offer and the owner may still be allowed to accept or counter offer on the bid.

In flow 870, at a stage 872 a decision may be made to convert a bid to a deal. If a NO branch is taken, then flow 870 may transition to another stage, such as back to the stage 872, for example. If a YES branch is taken, then flow 870 may transition to a stage 874 where a deal or deals are generated by data input received from owners who decided to convert bids they received into deals. Each owner may craft their deal according to their specific needs. At a stage 876 data representing the generated deal(s) may be published by a publisher that receives the data representing the generated deal(s). Data representing a generated deal may be packaged or otherwise formatted for publication by different publishers and/or different platforms, different programming languages, different media formats, etc. At a stage 878 a determination may be made as to whether or not a deal has been accepted. Acceptance may be by any method provided by the media the deal is published on (e.g., by selecting an icon or object on a touchscreen of a client device). If a NO branch is taken from the stage 878, then flow 870 may transition to another stage, such as back to the stage 876, for example. If a YES branch is taken from the stage 878, then flow may transition to a stage 880 where an accepted the deal may be consummated (e.g., closing the deal) by tendering of payment. In the event that a plurality of customers accepted the deal, DS 801 may award the deal to the customer who is the first to tender payment. For example, if the deal is published to one-thousand customers and twenty of those customers accept the deal, then the first of those twenty that completes the actions necessary to tender payment may be regarded by DS 801 as the first customer to accept.

In flow 870, owners (Sₐ-Sₙ) that are not associated with CS 401 may generate deals at the stage 874. For example, owners (Sₐ-Sₙ) may have listings that customers (Cₐ-Cₙ, Uₐ-Uₙ) may be interested in based on data communicated between CS 401 and DS 801. DS 801 may communicate data to owners (Sₐ-Sₙ) that may be used by the owners (Sₐ-Sₙ) to determine whether or not they wish to generate a deal to be published to potential customers. In some examples, owners who generate deals may be apprised by DS 801 of competing deals and/or acceptance of competing deals generated by other owners. In some examples, prior to an acceptance of a deal, an owner may rescind or modify the deal they generated. For example, the information on competing deals may compel the owner to rescind their deal or modify their deal (e.g., up the asking price if other owners are getting acceptances at higher prices).

In some examples, prior to any acceptance of an offer, a counter offer, or an inquiry bid, an entity (e.g., customer, owner) may rescind an amount that was bid or a counter offer that was issued. For example, if a customer initially bids one or more amounts (e.g., $660) on one or more listings (e.g., in “Search Results” and/or “Inquiry Results”), prior to any owner accepting an offer, the customer may rescind the bid amount. As one example, a rescinded bid may terminate ability of any owner to accept. As another example, a rescinded bid may be replaced with a different bid amount or amounts (e.g., the $660 is lowered to $590 or is increased to $700). If multiple bids are made for multiple listings, each bid may be individually rescinded and may result in an owner of a listing whose bid is timely rescinded to accept that bid or may result in the bid amount being replaced with a different bid amount. A rescinded bid may be to other bid parameters, such as number of days of stay at the listing or a date range for a stay at the listing, for example. As one example, if a customer initially bids $660 for three days of stay at a listing, the customer may timely rescind to change the bid amount and bid parameters, such that a replacement bid may comprise a bid of $440 for two days of stay at a listing. As described above, so long as no bid has been accepted or the bid window has not closed, then the rescinded bid may go into effect and the customer may submit a replacement bid with different bid amounts and/or bid parameters.

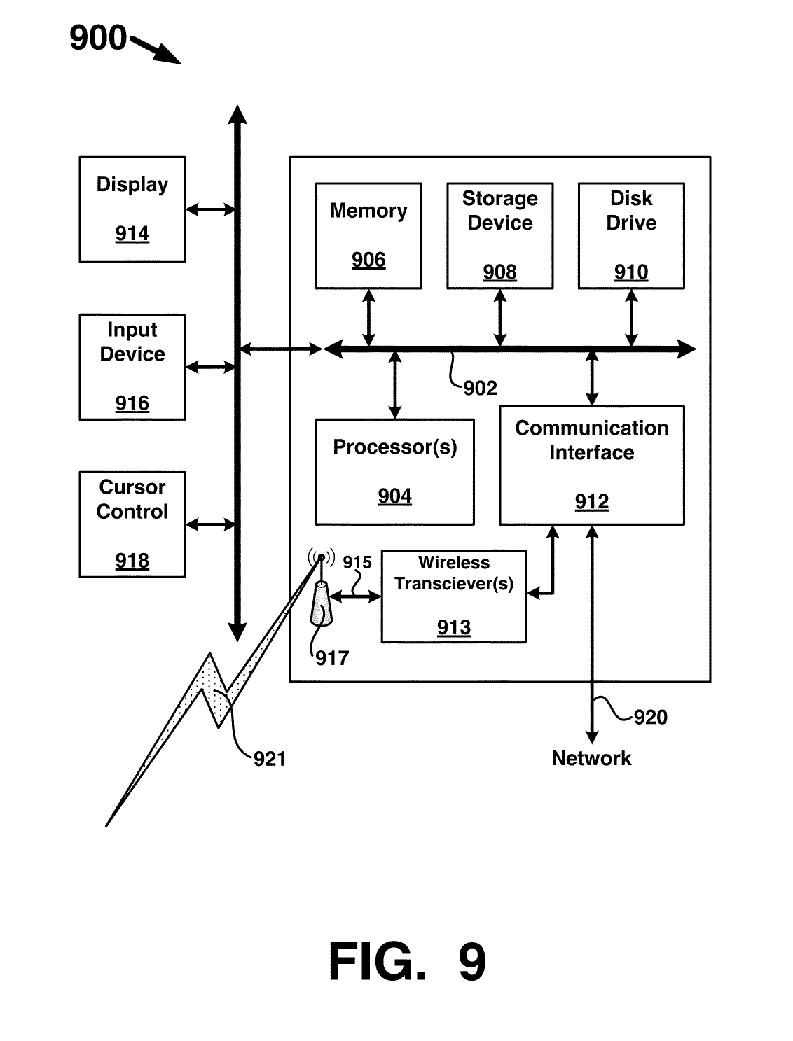

FIG. 9 illustrates an exemplary computer system that may be used in a needs based auction system. Computer system 900 may be operable and/or configured to implement one or more of flows 100, 200, 300, services, systems, client devices, compute engines, compute resources, networked compute resources, computing devices, and networked computing devices, described herein and/or depicted in FIGS. 1-8. In some examples, computer system 900 may be used to implement computer programs, algorithms, applications (APP's), API's, configurations (CFG's), methods, processes, or other software to perform the above-described techniques. Computer system 900 may include a bus 902 or other communication mechanism for communicating information, which interconnects subsystems and devices, such as one or more processors 904 (e.g., μC, μP, DSP, ASIC, FPGA, multi-core processor, Baseband processor, etc.), system memory 906 (e.g., RAM, SRAM, DRAM, Non-Volatile memory (NVM), Flash Memory), storage device 908 (e.g., Flash Memory, ROM), disk drive 910 (e.g., magnetic, optical, solid state), communication interface 912 (e.g., modem, Ethernet, WiFi, WiMAX, WiFi router), display 914 (e.g., CRT, LCD, touch screen), input device 916 (e.g., keyboard, stylus), and cursor control 918 (e.g., mouse, trackball, stylus). Some of the elements depicted in computer system 900 may be optional, such as elements 914-918, for example and computer system 900 need not include all of the elements depicted.

According to some examples, computer system 900 may perform specific operations by processor 904 executing one or more sequences of one or more instructions stored in system memory 906. Such instructions may be read into system memory 906 from another non-transitory computer readable medium, such as storage device 908 or disk drive 910 (e.g., a HD or SSD). In some examples, circuitry may be used in place of or in combination with software instructions for implementation. The term “non-transitory computer readable medium” refers to any tangible medium that participates in providing instructions to processor 904 for execution. Such a medium may take many forms, including but not limited to, non-volatile media and volatile media. Non-volatile media includes, for example, optical, magnetic, or solid state disks, such as disk drive 910. Volatile media includes dynamic memory, such as system memory 906 for example. System memory 906 may comprise non-volatile memory, volatile memory or a combination of those types of memory. Non-limiting examples of non-transitory computer readable media may include but are not limited to floppy disk, flexible disk, hard disk, solid state disk (SSD), optical disc, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read and/or write (e.g., access data).

Instructions may further be transmitted or received using a transmission medium. The term “transmission medium” may include any tangible or intangible medium capable of storing, encoding or carrying instructions for execution by the machine, and includes digital or analog communications signals or other intangible medium to facilitate communication of such instructions. Transmission media may include but is not limited to coaxial cables, copper wire, and fiber optics, including wires that comprise bus 902 for transmitting a computer data signal. In some examples, execution of the sequences of instructions may be performed by a single computer system 900. According to some examples, two or more computer systems 900 coupled by communication link 920 (e.g., LAN, Ethernet, PSTN, USB, FireWire, Thunderbolt, one or more varieties of wireless networks such as IEEE 802.x, Bluetooth (BT), Near Field Communication (NFC), Software Defined Radio (SDR), Hack RF, or others, etc.) may perform the sequence of instructions in coordination with one another. Computer system 900 may transmit and receive messages, data, and instructions, including programs, (i.e., application code), through communication link 920 and communication interface 912. Received program code may be executed by processor 904 as it is received, and/or stored in disk drive 910, or other non-volatile storage for later execution. Computer system 900 may optionally include a wireless transceiver 913 in communication with the communication interface 912 and coupled 915 with an antenna 917 for receiving and/or transmitting RF signals 921 (e.g., using one or more radios) such as from a WiFi network, BT radio, or other wireless network and/or wireless devices, for example. Examples of wireless devices and/or wireless communication systems may include but are not limited to those depicted in FIGS. 4-6 and 8 (e.g., 412, 480, 460, 830, 812, 860, 490, 401, 439, 890, and 801, etc.).

Although the foregoing examples have been described in some detail for purposes of clarity of understanding, the above-described conceptual techniques are not limited to the details provided. There are many alternative ways of implementing the above-described conceptual techniques. The disclosed examples are illustrative and not restrictive.

What is claimed is:

1. A method of needs based auction bids, comprising:
receiving, on a centralized service operative to initiate a first call to a first one or more networked computing devices, data representing a bid for a listing, the data representing the bid including a bid amount, a bid window, and occupancy data;
tendering, on a payment service operative to initiate a second call to a second one or more networked computing devices, data representing a payment for the bid amount;
placing a hold on the data representing the payment;
receiving, by an escrow service, the data representing the payment if the bid has been accepted prior to closing of the bid window; and
transferring, the data representing the payment from the escrow service to an owner account.

2. The method of claim 1, wherein the receiving by the escrow service occurs after taking occupancy of the listing.

3. The method of claim 1, wherein bidding for the listing is terminated by closing of the bid window.

4. The method of claim 3, wherein the hold on the data representing the payment is released when the bidding is terminated.

5. The method of claim 4, wherein the data representing the payment is refunded to an account the data representing the payment was tendered from.

6. The method of claim 1, wherein the bid is submitted for a plurality of listings and the bid amount is identical for each listing in the plurality of listings.

7. The method of claim 1 and further comprising:
presenting, by the centralized service operative to initiate a third call to a third one or more networked computing devices, data representing an inquiry bid for one or more other listings.

8. The method of claim 1 and further comprising:
converting, by a deal service operative to initiate a fourth call to a fourth one or more networked computing devices, the bid into data representing a deal; and
publishing the data representing the deal.

9. A method of needs based auction bids, comprising:
receiving, on a centralized service operative to initiate a first call to a first one or more networked computing devices, data representing different bids for a plurality of listings, the data representing the different bids including different bid amounts, a bid window, and occupancy data for the plurality of listings;
tendering, on a payment service operative to initiate a second call to a second one or more networked computing devices, data representing a first payment for a highest bid amount of the different bid amounts;
placing a hold on the data representing the first payment;
receiving, by an escrow service, data representing a second payment if the bid has been accepted prior to closing of the bid window, wherein the data representing the second payment comprises an amount that is less than or equal to the data representing the first payment; and
transferring the data representing the second payment from the escrow service to an owner account.

10. The method of claim 9, wherein the receiving by the escrow service occurs after taking occupancy of the listing.

11. The method of claim 9, wherein bidding for the plurality of listings is terminated by closing of the bid window.

12. The method of claim 11, wherein the hold on the data representing the first payment is released when the bidding is terminated.

13. The method of claim 12, wherein the data representing the first payment is refunded to an account the data representing the first payment was tendered from.

14. The method of claim 9 and further comprising:
presenting, by the centralized service operative to initiate a third call to a third one or more networked computing devices, data representing an inquiry bid for one or more other listings.

15. The method of claim 1 and further comprising:
converting, by a deal service operative to initiate a fourth call to a fourth one or more networked computing devices, at least one of the different bids into data representing a deal; and
publishing the data representing the deal.

16. A needs based auction bid system, comprising:
a compute engine in data communication with a plurality of interfaces including
a first interface operative to receive data representing a bid for a listing, the data representing the bid including a bid amount, occupancy data, and a bid window;
a second interface operative to tender data representing a payment of the bid amount from an account;
a third interface operative to place the data representing the payment on hold;
a fourth interface operative to communicate the data representing the bid;
a fifth interface operative to determine if the bid window has closed, to terminate bidding if the bid window has closed, and to release the hold on the data representing the payment;
a sixth interface operative to determine if the bid for the listing has been accepted and to place the data representing the payment in escrow if the bid for the listing is accepted; and
a seventh interface operative to transfer the data representing the payment from escrow to another account.

17. The system of claim 16 and further comprising:
an interface operative to communicate data representing an inquiry bid using data associated with the data representing the bid.

18. The system of claim 16 and further comprising:
an interface operative to communicate data representing a counter offer to the data representing the bid.

19. The system of claim 16 and further comprising:
an interface operative to convert the data representing the bid into data representing a deal; and
another interface for publishing the data representing the deal.

20. The system of claim 19 and further comprising:
an acceptance interface to receive the data representing the payment upon acceptance of the data representing the deal.
